(19) United States
(12) Patent Application Publication
(10) Pub. No.: US 2012/0072276 A1
(43) Pub. Date: Mar. 22, 2012

(54) Method, System and Apparatus for Multi-Platform Broadcast Marketing

(76) Inventor: Marlo Stivers, Califon, NJ (US)

(21) Appl. No.: 13/229,714

(22) Filed: Sep. 10, 2011

Related U.S. Application Data
(60) Provisional application No. 61/381,521, filed on Sep. 10, 2010.

(51) Int. Cl. G06Q 30/02; G06Q 30/06

(52) U.S. Cl. 705/14.17; 705/14.69

(57) ABSTRACT

An advertising social network grid system and method for enabling a user/advertiser to buy and schedule advertisement spots on multiple media-platforms in a cost efficient manner using an electronic device. The system includes a computer-implemented advertising network grid including a server with a database adapted to transmit and receive messages. The server is in communication with at least one broadcast network. Content entry means is included for entering advertisement content. Calendar means is provided for buying and scheduling at least one date and time for airing advertisement content. Region selection means is provided for selecting at least one region located within the broadcast network. Means for receiving and storing advertisement content is provided, and a central processor processes the advertising spot data and transmits it to the broadcast network for playing the advertising spot.

### CROSS-REFERENCE TO RELATED APPLICATIONS

This application is a non-provisional application of U.S. Ser. No. 61/381,521 filed Sep. 10, 2011, entitled “Method, System And Apparatus For Multi-Platform Broadcast Marketing”, the disclosure of which is hereby incorporated by reference in its entirety.

### BACKGROUND OF THE INVENTION

1. Field of the Invention

The present invention proposes a broadcast marketing system and method of using same. As used herein, the broadcast marketing system and method provides an integrated marketing system that provides an affordable venue for marketing goods and services on a plethora of broadcast mediums, while also providing a social network dynamically presenting news reports and advertising feeds and tracking consumer purchases and interests.

2. Description of the Related Art

Radio advertising reaches a large audience and provides the ability to target a specific group of consumers. Radio advertising is considered one of the main venues for marketing a business. There are approximately 13,000 radio stations (roughly 8,800 FM and 5,000 AM stations) broadcasting throughout the United States, reaching over 94% of the US population ages 12 years old and upward each week, offering an attractive advertising venue. While radio advertising costs less than television advertising, the costs associated with radio advertising can be significant, and are driven by the time of day and the popularity of the radio program. Radio advertising costs include both the cost to produce the radio commercial and the air time cost to run the radio ad on the air. Air time is generally sold in “spots”. The cost of the spot will depend upon the audience size, the time of day the ad runs, and the length (minute/second) of the spot. Times of days are typically broken into five different categories, including the “Morning Drive” (6:00 a.m.-10:00 a.m.), “Mid-Day” (10:00 a.m.-3:00 p.m.), “Afternoon Drive” (3:00 p.m.-7:00 p.m.), “Evenings” (7:00 p.m.-12:00 midnight) and “Overnight” (midnight-6 AM).

Advertisement spots are typically marketed by the media to prospective advertisers. The advertiser is normally a buyer in a seller's market. Spots are offered at a price that may or may not be negotiable, being generally nonnegotiable when the spot is in a large market or market with upscale customers. Implementation of the Internet and the World Wide Web has facilitated in providing a number of advertising techniques.

One advertising technique includes selectively targeting advertisements and programming to different demographic audiences. Examples can be found in U.S. Pat. Nos. 5,636,346 and 7,444,658. Another advertisement technique includes integrating commercial advertisements with computer software programs. Examples can be found in U.S. Pat. Nos. 5,105,184, 5,937,392, and 6,029,045. These advertising techniques are not directed to buying advertisement spots, but instead are directed to advertising technologies.

Currently, the selling and purchasing of advertising space, particularly on for radio spots, is both costly and difficult for many companies. Often the company must go to the specific owner of each of the radio stations and when seeking to purchase advertisement space is directed to an advertising agency to handle the advertisement spot development and purchase. Not only does this result in significant cost to the advertiser, but results in significant time delays before the advertisement is issued on air.

Various advertising auction systems and methods have been provided. Generally content/opportunity providers publicize to advertisers that they have an advertisement spot open. The advertisers place bids for the advertisement spot and, if the bid is accepted, the selected advertiser receives the advertisement spot. Examples can be found in U.S. Pat. Nos. 6,324,519, 7,085,732, 7,661,116, and as well as at onemediaplace.com (AdAuction.com).

Consumers engage in a number of different media daily. From newspapers and magazines to radio, TV, the Internet, websites, blogs, podcasts, and personal electronic devices such as that currently sold under the trade names iPod and Kindle. Today consumers look to a variety of marketing platforms to get news and information on products that make their lives easier. As a marketer, this means that companies now need to choose a variety of marketing platforms—online and offline—that work together to create the best mix for their target consumers.

The art appreciates that there are many constraints on an advertiser's ability to locate media outlets in which to advertise, and constraints as to finding affordable advertising outlets. This is particularly acute for advertisers wanting to use smaller media outlets to advertise to local or rural communities. There is a need in the art for a system and method that provides advertisers with a one-stop-shopping forum that allows them to schedule advertisement spots directly and to select a block of spots from a plurality of air time spots for multi-platform advertising. There is further a need in the art for a system and method that provides advertisers the ability to block advertising spots in a cost-sharing manner.

### SUMMARY OF THE INVENTION

Establishing brand awareness and sustaining recognition is one of the biggest hurdles for any Company. The present invention relates to a solution by providing multiple avenues of content distribution at once that allows a company to promote its name and substantiate its product and or service cost effectively. A method and system is proposed that provides a fully operating broadcasting grid that ensures brand awareness to help assist in substantiating companies for long term recognition. The broadcasting grid enables broadcasting of reports live on air by a trusted voice with the advertiser's feature appearing on every radio station's website that the company broadcasts on slated as “Headline News” and allows additional information, instructional videos and promotional literature, coupons and sample gift giveaways published and offered on the front page of electronic local news magazines weekly.

As a marketer, companies need to choose a variety of marketing platforms—online and offline—that work together to create the best mix for their target consumers. The subject system and method provides a unique integrated marketing approach to attract consumers, engaging consumers on multiple media platforms.

The present invention is directed to an advertising network grid system for enabling a user/advertiser to buy and schedule advertisement spots on multiple media-platforms using an electronic device having capability (i) to receive and transmit messages, (ii) accept input via a user interface, and (iii) display messages on an electronic display. The system comprises a computer-implemented advertising network grid including a server with a database adapted to transmit and receive messages from the user's electronic device, the server being in communication with at least one broadcast network.

Content entry means is provided for entering content provided by the user/advertiser as advertisement content. The system also includes calendar means for buying and scheduling at least one date and time for airing the advertisement content. Region selection means for selecting at least one region located within the broadcast network wherein the region includes a broadcast channel associated therewith is provided. The system includes means for receiving and storing advertisement content, selected date and time and the region and/or channels associated therewith as advertising spot data. A central processor adapted to receive and process the advertising spot data and transmitting same to the broadcast network for playing the advertising spot at the selected date and time.

A method for enabling a user/advertiser to buy and schedule advertisement spots on an advertising network grid system is provided. The system of the method provides the ability to schedule advertising spots on multiple media-platforms using an electronic device having capability (a) to receive and transmit messages, (b) accept input via a user interface, and (c) display messages on an electronic display. The method comprises the steps of: (i) requesting at least one advertising spot on at least one broadcast network using a computer-implemented advertising network grid including a server with a database adapted to transmit and receive messages from the user's electronic device, the server being in communication with at least one broadcast network; (ii) entering content through entry means included within the grid for entering content provided by the user/advertiser as advertisement content; (iii) selecting at least one date and time for reserving the advertising spot through calendar means included within the grid for buying and scheduling airing of the advertisement content; (iv) selecting at least one region through selection means included within the grid for selecting at least one region located within the broadcast network wherein the region includes a broadcast channel associated therewith; (v) receiving and storing the advertisement content through database means, and selected date and time and the region and/or channels associated therewith and reserving same as advertising spot data; (vi) receiving and processing the advertising spot data through a central processor; and (vii) transmitting the advertising spot data to the broadcast network for reserving and playing the advertising spot at the selected date and time.

The above and other aspects, features and advantages of the present invention will become apparent from the following description read in conjunction with the accompanying drawings, in which like reference numerals designate the same elements.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1 is a flow chart illustrating an embodiment of the advertising network grid system and method;

FIG. 2 is a flow chart of an embodiment of the advertising network grid method;

FIG. 3a is a webpage snapshot of the “Home” page of the advertising network grid system and method;

FIG. 3b is cross-sectional view of the webpage snapshot showing the “Home” tool bar;

FIG. 4a is a flow chart illustrating an embodiment of the calendar means and region selection means;

FIG. 4b is a webpage snapshot of the calendar means illustrated when the “Albany N.Y.” regional link is selected;

FIG. 4c is a webpage snapshot of the calendar means illustrated when the “Boston Mass.” regional link is selected;

FIG. 5a is a webpage snapshot of the “Request Airtime” link;

FIG. 5b is a webpage snapshot of administrative contact response upon a user submitting the “Request Airtime” page from the “Request Airtime” link;

FIG. 6 is a flow chart illustrating the “Program Themes” link, and sub-links leading to the themes and individual topic categories;

FIG. 7a-7c illustrated webpage snapshots of the “Add Events” link showing the scheduled advertising spots and color coding for each Region/and or city;

FIG. 8 is a webpage snapshot of the “Registration” link;

FIG. 9 is a webpage snapshot of the “Login” link;

FIG. 10 is a snapshot of a pricing structure depending on user type, etc.; and

FIG. 11 is a webpage snapshot of the “Professionals Connect”/business-to-business connect service link of the system and method.

### DETAILED DESCRIPTION OF THE INVENTION

A novel marketing system and method is provided by way of the subject invention that offers companies/individuals the opportunity to engage with consumers on several media platforms at once, from radio to websites, blogs, podcasts and other Internet services that will put the company's/individual's brand all over the Web—and all over consumers' minds. Currently, marketing services cost hundreds of thousands of dollars and several weeks to orchestrate. Advantageously, the subject system and method is directed to “integrated marketing” promotions for a nominal amount, for example $100 dollars. What is more, the subject system and methods provides the ability to set up the integrated marketing plan rapidly by selecting the elements of the campaign with a click of the computer mouse. An entire multimedia campaign can be developed in minutes, and with significant cost savings to the advertiser. The system and method places a company's brand on multiple media platforms, including: (i) on selected radio morning shows; (ii) in stores; and (iii) all over the Internet on the World Wide Web. What's more, a user/company can link its promotions on the system and method to its own websites and social network pages, such as that used by the trade name Facebook, and use its marketing materials in press packages that will attract newspaper and magazine journalists, TV reporters and consumers everywhere.

The broadcast marketing system and method of using same enables an integrated marketing system providing an affordable venue for marketing goods and services on a plethora of broadcast mediums, while also providing a social network dynamically presenting news reports and advertising feeds and tracking consumer purchases and interests. The system and method dynamically presents reports/news feeds/advertisements to consumers through a plethora of broadcast mediums—including Internet, webcasts, radio, television, etc.—shared by one or more advertisers (retailer, merchants, etc.). Consumer activity is tracked on the system and method to provide feedback to advertisers as to market trends, purchases, interest, etc., so that the retailer/merchant can readily determine the effectiveness of the marketing report/advertisement. In turn, tracking means is provided to also provide gifts/rewards to consumers based on purchases and/or activity on the system.

It is to be understood that the present invention may be implemented in various forms of hardware, software, firmware, special purpose processors, or a combination thereof. The present invention may be implemented in software as an application program tangibly embodied on a program storage device. The application program may be uploaded to, and executed by, a machine comprising any suitable architecture. Exemplary embodiments of such architectures include cell phones, smart phones, net book computers, computers, computer systems, and other devices comprising one or more microprocessors. The various processes and functions described herein may be either part of the microinstruction code or part of the application program (or a combination thereof) which is executed via the operating system. In addition, various other peripheral devices may be connected to the computer platform such as an additional data storage device and a printing device.

It is also to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

It is an object of the present invention to solve the problem of buying and reserving air time on a broadcasting network at affordable costs. It is another object of the present invention to solve the problem of a company needing to go through different agencies in order to buy and reserve air time on a broadcasting network. It is yet another object of the present invention to create a grid/platform that allows a company to buy and reserve air time on a broadcasting net directly, with the capability to select the time of day for multiple days (and multiple times) through direct reservation and purchase. It is yet another object of the present invention to provide the ability to allow companies to split or share costs for advertising spots by splitting/sharing airtime spots. It is yet another object of the present invention to provide advertising partnerships between companies for promoting each other's businesses. Further, another object of the present invention is to provide an advertising market grid that allows a company to reserve and buy air time on a broadcast medium including radio, television, podcasts, and/or Internet—individually or in combinations thereof.

Additional objects and advantages of the present invention shall become apparent upon consideration of the present specification, figures and claims, as originally filed herewith, in their totality.

The present invention a system for collecting and processing data (advertising date), advertising content, from one or more companies for buying and scheduling advertising spots occurring on a broadcast network, Internet, or other venue. Data collection and processing employs a device that is able to: (i) receive and transmit messages, (ii) accept input via a user interface, and (iii) display messages on an electronic display. A receiving device receives the advertisement content and scheduling at a central processing station or distributed processing stations. The received advertisement content is stored as attendant data, and processed into efficacy data for airing.

The proposed method and system provides calendars for each radio station participating in the system, and further groups the radio stations together by regions, preferably 5 regions. Each calendar day turns into a transaction. There are at least two prices available; a region price and a city price. If a company x has a location partner, company y, that is offering company y's product or service for sale in the city that company x wants to establish its product in, the proposed method and system allows company x and y to publish their name address and phone number next to each other's content and mention their names live on air during each other's segments. Each respective company will incur a percentage, preferably 15%, of the media purchase in the city or cities that each company is promoting in only. Pricing according to the proposed method and system also may vary due to market density.

Ordering air time by way of the grid includes clicking on the order button wherever the user is on the grid network of sites, leading the user back to a “requested air time” link. Once the user places the order and clicks submit one of the system's administrative staff will contact the user to finalize the user's purchase. The system staff will send the user an invoice through electronic payment mediums, such as that used under the mark PAYPAL, with an affidavit from the radio station or stations that the user is publicizing its reports on. This also secures the user's placement on the broadcasting grid for the user's write-up and advertisement. A user may elect buy multiple radio slots over a long period of time. Another option is available to a user that wants online exposure, but doesn't want to book radio time. In this mode the user elects to participate in affiliate marketing with advertisements and promotions but does not elect to purchase radio air time.

The present system and method makes radio time scheduling easy, flexible and fun. There are approximately (4) slots available per radio station each day of the business week. The present system and method provides a program that will accommodate up to 4 clients a day in two ways on each radio participating. Two clients can choose to buy by the region on the same day and two clients can chose to concentrate in one city at a time; the pricing structure of the subject system and method enables the clients to do both with no hassle. Preferably, the clients are grouped by Program Theme in order to fully benefit from the program.

The system of the subject invention helps companies leverage the top 100, preferably morning radio show programs, across the nation, for example U.S.A, and combine this outreach with extensive social media marketing efforts—cheaper and more efficiently than ever before. The key to success: studies show that morning radio offers the most successful advertising results—greater than magazines, newspapers and even television. Through use of the subject system and method, a company can capitalize on consistent radio time blocks that link it with other manufacturers, retailers and professionals in a way that makes sense and drives results. This outreach encompasses all regions of the country—giving participating companies far-reaching media broadcast time at unbelievably low pricing. Once a company's radio campaign is in place, the system and method can further yield support via broadcast advertising with savvy web-based social marketing—helping brand awareness to dramatically increase.

The system offer programs for Manufacturers, Retailers and Professionals. Wherein Manufacturers, Retailers and Professionals can purchase programs on a nationwide scale or by individual regions. A variety of topic categories in each region is provided, each with their own webpage links through the system, featured each day of the week throughout the month. All categories are subject to change, but a typical week is illustrated in Table I below (view the calendar for a complete list of dates and times available per category):

TABLE I

| DAY | CATEGORIES* |
|---|---|
| Monday | Professionals, Beauty & Wellness, Exercise, Fashion, Pets |
| Tuesday | Cosmetic, Aesthetic, Nutrition, Music |
| Wednesday | Restaurants, Healthcare |
| Thursday | New Trends, Beauty, Tweens, Teens |
| Friday | Travel, Movies, Videos, Events, Books |

*A plethora of different categories are contemplated, these categories are examples of categories that can be used. Open slots each day of the week may also be provided for additional advertising and miscellaneous categories.

Each day, the system runs a timed radio spot, preferably 30-second radio spots on FM stations throughout the nation/region, for example the U.S.A. The first 15 seconds of the spot are typically devoted to promoting manufacturers. The next 15 second of the spot will then promote retailers. Preferably 10-week subscription blocks may be available. In addition, any manufacturer wishing to buy the entire 30-second slot can book time for the same day as a manufacturer and a retailer in any region. At the conclusion of this first 10-week block, the next block will re-queue and roll continuously forward. Advantageously, with the subject system and method booking radio airtime is as easy as booking a vacation—the user/advertiser simply selects and reserves available time slots through the system, paying via credit card, etc. Then, the user/advertiser submits its on-air and web content to editors of the system, who will work with the user/advertiser to ensure appropriate length, quality and content is provided optimized to move the user's/advertiser's customers to action and drive sales results. The process is collaborative and quick. The system is flexible, allowing an advertiser to advertise in its topic areas across the country, across certain regions or blitz a single region using different topics each day of the week.

Uniquely, the system offers a variety of different programs, including a manufacturer, retailer and professional tailored program. An example of the Manufacturer-tailored program is shown below in Table II.

TABLE II
Manufacturer-tailored program:
System promotes company on the Top 100 listed Arbitron-rated
Morning Radio Show Programs in the U.S. The following lists several
opportunities and options to consider in marketing the company:

| | |
|---|---|
| Option A: | Mass market penetration: Enables an |
| | advertiser/company to buy airtime on a |
| | national scale to reach millions of |
| | consumers over a period (preferably 10 |
| | week). The top 100 cities will appear and |
| | the user will have the opportunity to buy |
| | by at least one block, preferably a block |
| | of 5. |
| Option B: | Regional feature: Enables an advertiser/ |
| | company to buy airtime in select regions/ |
| | individual regions. Then, user clicks on |
| | its category and buys time in the market |
| | and radio station on which it would like |
| | to promote itself. There is no restriction |
| | to the amount of markets and radio |
| | stations that the company can buy time |
| | on in the regional sections. |

Once the advertiser/company submits a copy of its proposed advertisement content to the system, a staff member will turn the content into a billboard advertisement that will be published on each radio station's website each day that the company is promoted on air. The content is also published, including commercial and instructional videos (and more), on one of the various system channels that produce Official Reports. Consumers will also be able to print the company's promotional offers or coupons, and find out where they can receive samples and gift giveaways of the company's product and/or service at local or national retail establishments that are supporting the company's efforts to establish its brand name. This will also enable the company to provide further education through direct response marketing of its product, service or event.

Each manufacturer can be linked on a weekly basis with at least one, and preferably up to 5, regional retailers, so part of the manufacturing campaign will include providing a set minimum value of samples for each linked retailer during a daily broadcast. Samples should be sent to the system, which will distribute them to linked subscribing retailers. Advantageously, the company can choose either a nationwide campaign or a single, concentrated regional campaign by buying time in markets of its own choice and promoting its content and material in those categories. A company can also choose a week-long blitz in a single city using different categories to advertise on the radio and be heard every day. Companies are linked to retailers eager to promote their product.

The Retailer-tailored program is a regionally based program only, since retailers tend to be local or regionally based. However, alternatively the retailer-tailored program may utilize mass market penetration nationally as in Option A above in Table II regarding the Manufacturer-tailored program. The retailer can select any and all regions across the country. Preferably, retailer list pricing differs from manufacturer pricing, but the net cost is the same for both, since each retailer linked to a manufacturer will be provided with product samples to cover the value of the cost difference. The booking and content submittal process is the same. Just log on to the system and follow the steps above to select the retail company's regional city or cities of choice, and then submit its advertising content.

Professional-tailored program (plus Food, Events, Movies, Video & Open blocks) provides a program similar to that of the Retailer-tailored program, with the sole difference that the cost is less to reflect the absence of product sample value.

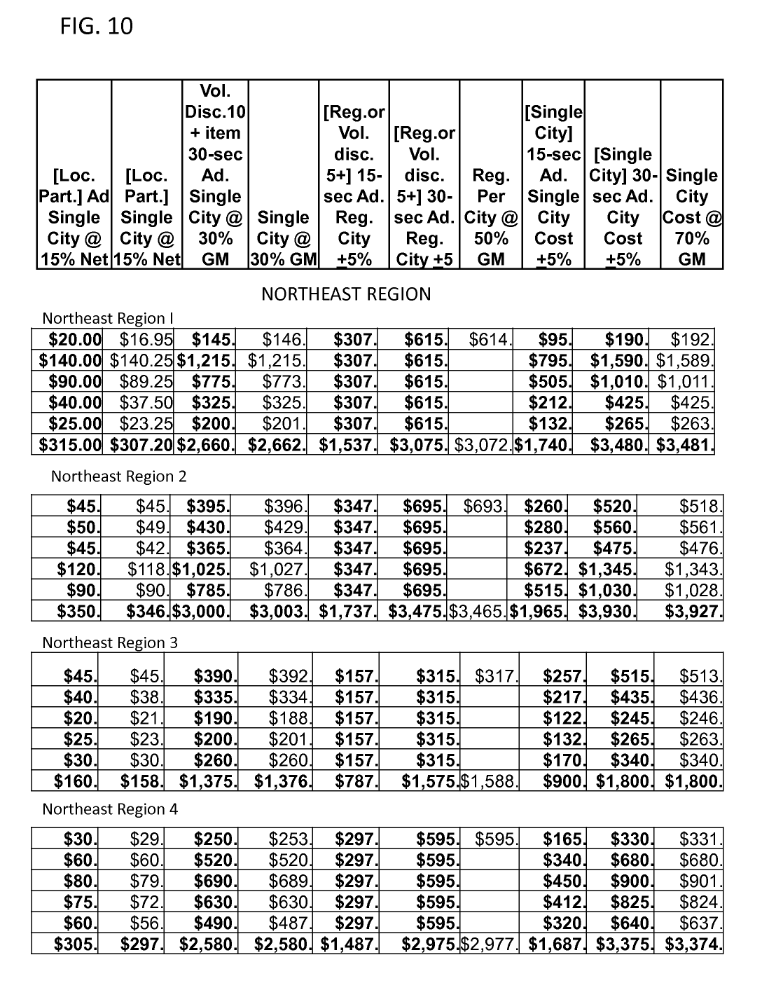

The system and method utilizes a broadcasting grid for daily nationwide exposure sustaining an interlocking commerce grid that produces results on a long-term basis. Advertisers/companies utilizing the system and method will beat the competition and grow in regions faster by allowing more retailers the opportunity to sell to potential buying public without high costs associated with advertising. This system has been developed to help generate and sustain substantial growth quickly and effectively, increasing procurement in a simplified way at the retail level near home and in the community. FIG. 10 shows an example of a pricing structure for the subject system.

An integrated marketing service is rendered by the system and method, as it conducts business with companies at the click of a mouse on a budget of just a few hundred dollars. In addition, the system provides a full-time staff of working professional marketers and copywriters to help companies market their products and services professionally and effectively. Together, the system and method drives customers to companies' businesses, moving products off the shelf and increasing profits. Whether the company is a small clothing boutique, or a multi-national retail conglomerate, publicity, sales and marketing can be done with less hassle and less frustration with the system and method. For example, with the system and method, booking airtime on morning radio will be easier. At the same time, with all the promotional tools available to companies through the system and method's expansive network of websites and partners, companies stand to make a fortune on a tiny investment in advertising on the subject system and method.

With new media and Internet technologies, the present system and method creates marketing strategies that drive publicity, awareness and sales higher—cheaper and more efficiently than ever before. The key to success: Studies show that morning radio offers the most successful advertising results for a company's brand—greater than magazines, newspapers and even television. The system and method has collaborated with radios stations to Report the News. The system and method offers a variety of topic categories on the top 100 radio stations with their own webpage links through the system and method, featured each day of the week throughout the month. There are preferably six main Program Themed topics: Beauty and Fashion, Creative Arts, Health and Wellness, New Trends, Home & Garden and Travel. Each topic is linked to a National Resource. The front page of each national resource provides latest breaking news around the world. Each Program Theme is preferably condensed into a 15-second morning radio report brought to the listening public by their favorite morning show host. Reports are either live or prerecorded. The Reports are also strategically placed on each radio station's website and listed as “Headline News”. The National Resources are also used as portals to the region, town and city in which the company promoting its product and service.

The system and method utilizes software from retail networks to support brands sold in the retail's online or offline affiliated outlets, providing a novel, unique approach in promoting the sale of goods and services, while rewarding consumers with cash back on their product purchases. Preferably, rewarding customers is achieved through implementation of prepaid credit cards, such as those under the trade name VISA®, coupons, consumer rewards, etc. at store locations and online. The system and method revolutionizes the broadcasting of local promotional content in a format supporting economic growth for the radio stations, the broadcasters, Ad Agency's, PR Firms, retailers, merchants, service providers and others with a message to convey directly to the public.

Preferably, the system and method buys 60-second spots on top radio morning show programs and then passes the savings on to the method and system customers by allowing them to share in the headline news/advertising spot minutes. Each report/headline news spot can be divided up to (4) 15-second units that are broadcast together. The promotional content is read by the popular hosts of the morning radio programs and/or celebrities as a business report, not as advertising, so listeners are more likely to stay tuned. The subject system and method saves on up-front investment and maximizes revenue and publicity by using an innovative approach to media and marketing, combining radio broadcasting and online publishing to market products or services or promote events in a way that is easier and more cost-effective than ever before. Application of the subject system and method allows manufacturers and distributors to buy affordable publicity on top-rated morning drive-time broadcasts within a sponsored minute that is aired on local stations in regional markets domestically and internationally.

To enhance the system's radio promotion, the system and method consists of a variety of online publications featuring advertorials, press releases, videos, podcasts, blog posts, FACEBOOK® and TWITTER® feeds that are available to the vendors that buy airtime. An Internet platform is provided to allow thousands of companies to promote their goods and services on a local, regional national and international level at one time directly through the retail network that they sell through. For even greater impact, on the day the radio report is read, the radio stations feature the written copy of the broadcast report as headline news on their own websites. The subject system and method maintains visibility for each business report after it is aired as the reports are published on the front page of relevant keyword searches on Google, Yahoo and Bing in addition to forwarding media content to journalists worldwide. Furthermore, to engage consumer readership and build relationships in an active mode, the system and method also provides for publication of human interest stories of informative educational and anecdotal nature that appeal to consumers with an interest in Arts, Beauty, Business, Fashion, Health and Wellness, Lifestyle, New Trends and Travel.

The method and system provides a social network that creates instant demand to consumers listening to the radio station show programs in the US and abroad. Promotional reports are designed to enable companies to broadcast their headline news on a local single-city or regional level domestic and international level. Previously, there has been no way to track such marketing effectively without spending thousands of dollars in one local market. The subject system and method's unique platform enables businesses to use in-house marketing and advertising tools to increase revenue quickly while promoting and testing consumer response to products and services. An affiliate network platform is further provide that is associated with the system that allows consumers, businesses, schools, non-profit organizations and website owners to place icons and ad campaigns on their websites, mobile applications, mobile phones, computers and mobile pads to track purchases and receive reimbursement from the purchases they make on any of the networks. The system and method further offers a prepaid credit/cash membership card that preferably does not require any application for credit. The prepaid credit/cash membership card can be purchased at each local establishment participating, or purchased via electronically through online applications. Each retailer is provided its own platform to leverage media buys for its vendors/merchants and for consumers to receive cash back on prepaid cards monthly through a rewards program. The system provides a tracking system that enables every website owner and retailer to bring in revenue and increase traffic from products and services sold, as well as to enable each cardholder to receive revenue or a gift receipt by way of money from all purchases promoted via radio broadcast, online purchase or in-store promotion.

Currently, each industry is catered to national brands and retail partners that can afford to broadcast and place advertisements in newspapers and magazines nationwide. Advantageously, the subject broadcast marketing system encompasses broadcast, advertisements and social media, thus enabling monetary consumer rewards. The system tracks immediate return on investment within one half-hour of broadcast, which is essential to the success of small business owners because business owners are able to recover quickly from a nonresponsive audience. Each day a broadcast is aired a different copy of their release is produced in order to test pricing and product features and benefits affordably. The invaluable advantages that broadcast marketing system ensure long-term financial success.

The broadcast marketing system includes tracking means that provides the capacity, via prepaid credit cards, to convert consumer membership purchases into ‘gifted monies’/rewards from any online or in-store product/service appearing on the system's web-based promotional platform, on which all participating clients can create a presence. Tracking means also tracks consumer spending and trends for retail establishments, vendors, processors and banks worldwide. Through the tracking means, retailers/manufacturers/advertisers will be able to review reports daily for each of their network merchant accounts and their subsequent subaccounts, i.e., vendor (affiliate merchant) and individual consumer user account. The consumer sub account will enable retailers/manufacturers/advertisers to see all sales from all transactions within the network. As a result, the system: leverages consumer buying power; creates new market for prepaid credit/cash reward cards, which consumers can use anywhere to purchase whatever they desire; solves problem of consumer loyalty through rebate programs; established for scalability (for example, to serve up to a maximum of 4,200 manufacture' products per retailer on either single city or a regional, national and international level); and provide capacity to service thousands of vendors and their products in multiple categories per network at one time dependent on the retailers need.

Uniquely, the broadcast marketing system provides a true win/win differentiator for businesses and consumers, combining radio broadcast, a marketing platform, and social media for content-driven viral marketing. In so doing, the system: insures voice to all member populations and allows for monetizing their influence (bloggers, radio station celebrates, journalists, copywriters, not-for-profits, etc.); provides avenues for consistent, sustainable, results-oriented promotion; provides group purchasing power for advertising and promotion; and provides distribution of relevant information from relevant businesses to relevant people.

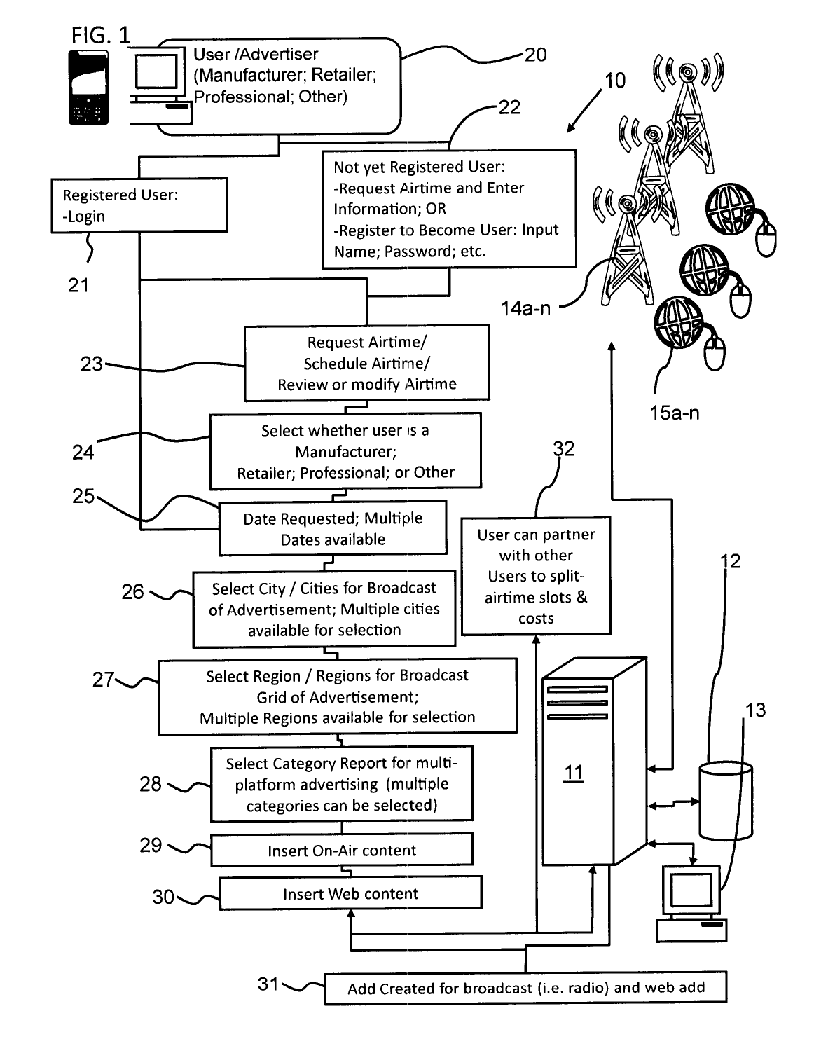

FIG. 1 is a flow chart illustrating an embodiment of the advertising network grid system and method, shown generally at 10. The advertising network grid system enables a user/advertiser 20 to buy and schedule advertisement spots on at least one, preferably on multiple media-platforms 14a-n (radio stations), 15a-n (internet websites), blogs, magazines, news reports, television broadcasting, podcasts, smart phone applications, social networks, YouTube®, and other broadcast mediums. The user 20 is preferably branched into groups, including Manufacturers, Retailers, and Professionals. However, a plethora of groups are contemplated, including Schools, Students, Teens, College Students, and College Campus groups, as well as other groups interested in utilizing the system's multi-platform advertising grid. User 20 utilizes an electronic device having capability (i) to receive and transmit messages, (ii) accept input via a user interface, and (iii) display messages on an electronic display. Preferably the user device utilized by user 20 is a desk-top computer, laptop computer, computer device in general, smart phone, mobile phone or Personal Digital Assistant (electronic handheld information device) (PDA).

The system comprises a computer-implemented advertising network grid including a server 11 associated with a CPU having a database 12, adapted to transmit and receive messages from the user's 20 electronic device. Server 11 is in communication with at least one broadcast network 14, preferably having a plurality of regions with channels to provide for broadcast on channels 14a-n (n being an indefinite integer dependant on the actual number of channels applicable in each situation). More than one broadcast network can be provided shown in general as an Internet website 15, preferably having a plurality of websites 15a-n. According to one aspect of the invention, the broadcasting network 14a-n, etc., includes top 100 radio stations' morning radio show programs. According to one aspect of the invention, the broadcasting network 14a-n, includes a single broadcast network; or alternatively a second/secondary advertising spot comprising internet advertising on at least one internet website venue (such as shown at 15a-n). Preferably a plurality of broadcasting networks is provided for multi-platform venue advertisement. The broadcast network is contemplated to further comprise at least one radio network, and at least one Internet website. The broadcast network may be/or include a television network, blogs, podcasts.

Content entry means 29, 30 is included in the system 10 for entering content provided by the user/advertiser as advertisement content. Content can include on-air content 29 and/or internet content 30. A user 20 may elect to insert content for both, or may elect to select content for just one or the other. Although on-air content 29 and internet content 30 are shown, other insert contents may be included. For example, the advertising content may include on air television commercial content, news, magazine, smart phone application, blog, podcast advertising content. The content itself, as entered in 29 and/or 30 may include written text, instructional videos, news, promotional literature, coupons and sample gift giveaways, and/or combinations thereof.

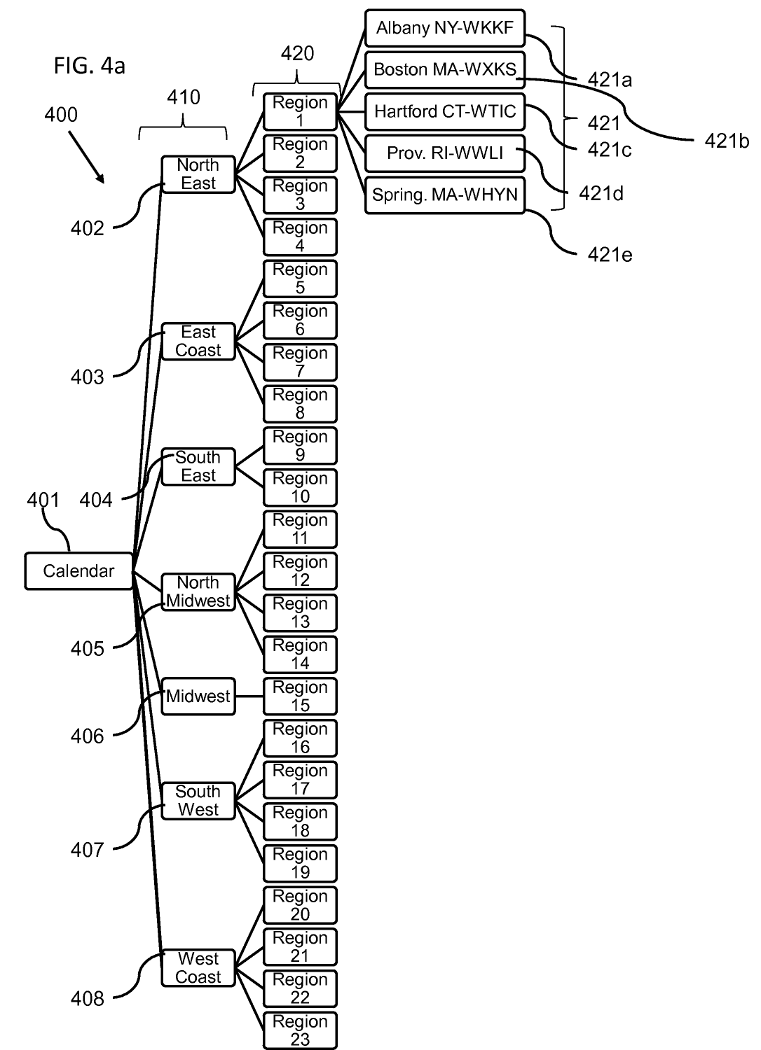

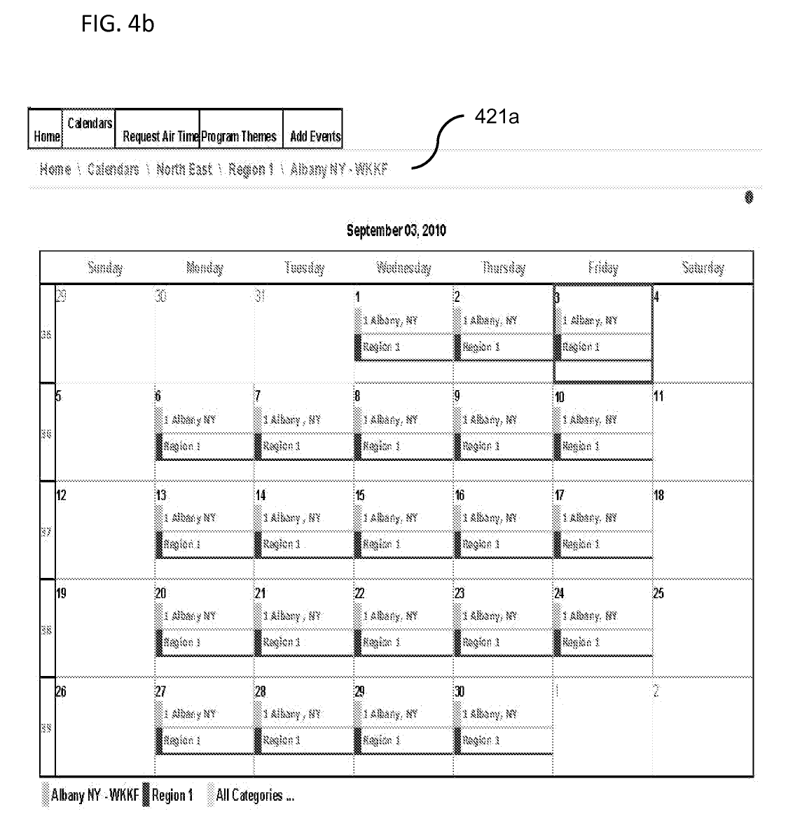

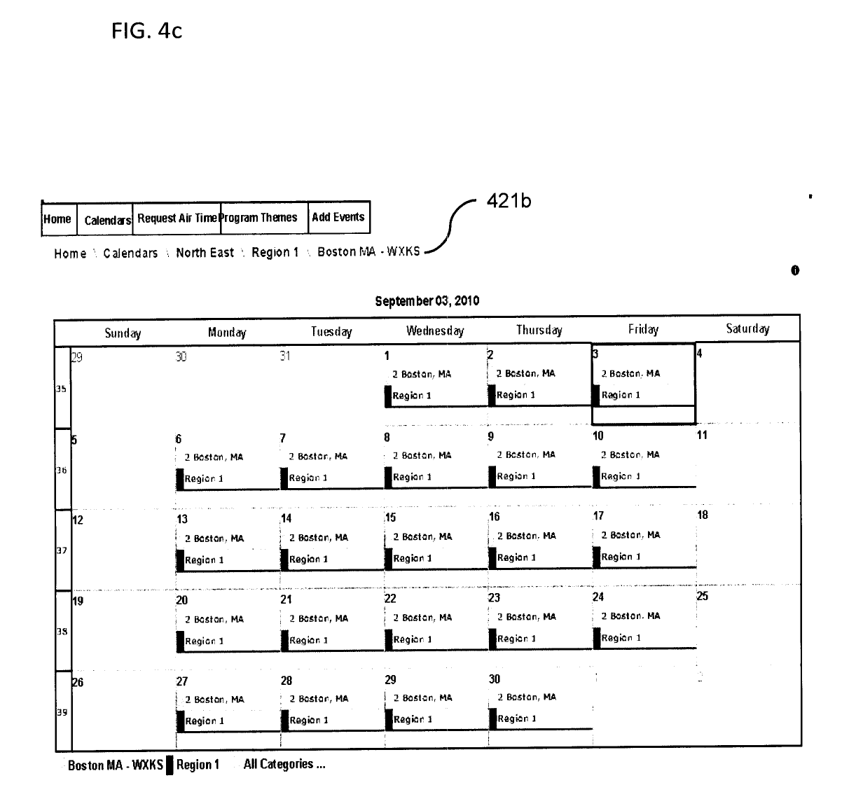

Calendar means 23, 25 is included in the system 10 for buying and scheduling at least one date and time for airing the advertisement content. User 20 selects “Request Airtime/Schedule Airtime/Review or modify Airtime” 23 and enters the “Date Requested”; multiple dates are available. (See FIGS. 4a-4c). Calendar means provides for daily, weekly and monthly scheduling of multiple dates and time for airing the advertisement content.

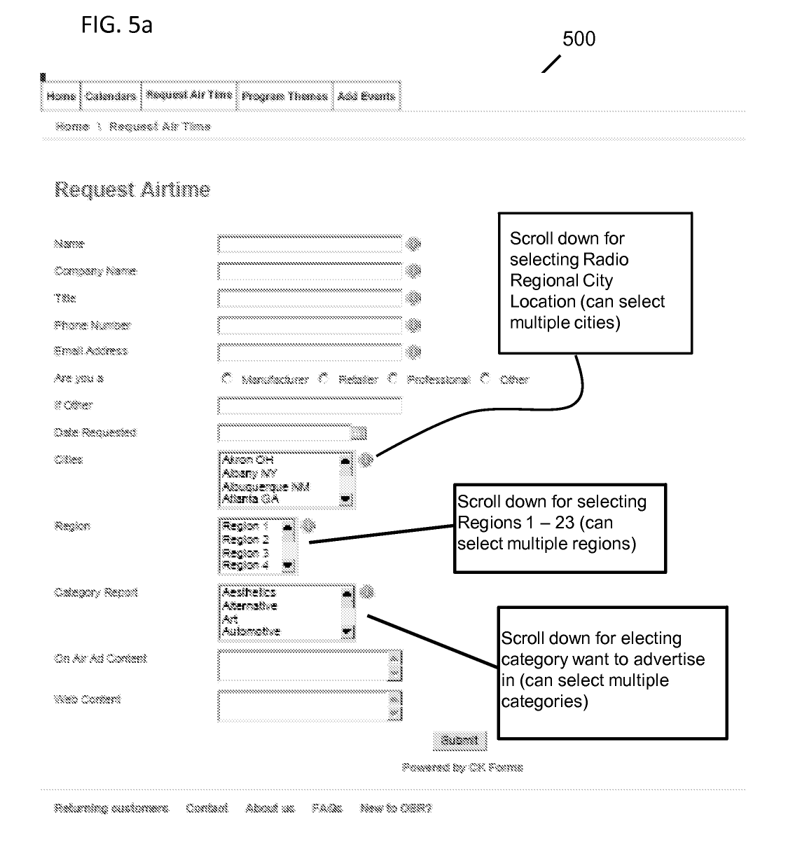

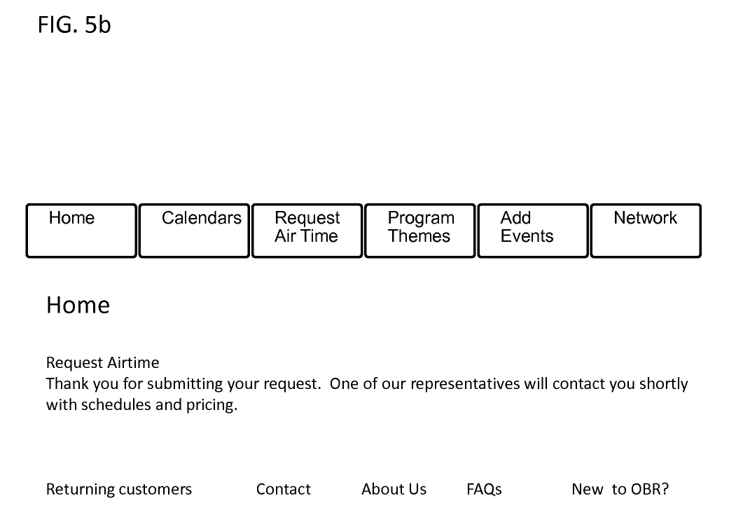

Region selection means via 26 (city selection) and 27 (region) is included in the system 10 for selecting at least one region located within the broadcast network wherein the region includes a broadcast channel associated therewith. User 20 can “Select City/Cities for Broadcast of Advertisement” 26 multiple cities can be selected wherein the user 20 can particularly select the city/cities for buying airtime. User 20 can “Select Region/Regions for Broadcast Grid of Advertisement”, 27 multiple regions can be selected. Each region includes at least one city with each city being associated with a broadcast channel, i.e. radio station. User 20 may elect to enter specific cities in a region via 26, and/or may elect an entire region 27 or regions. (See FIGS. 4a-5b). There is preferably a plurality of regions and each region preferably includes at least one city with a broadcast channel associated therewith. There is preferably a plurality of broadcast channels associated with each the region. There is a preferably plurality of regions and wherein each region includes at least one broadcast channel associated therewith correlating to a geographical city area.

Means for receiving and storing (server 11, database 12) is provided for receiving, storing advertisement content, selected date and time and the region and/or channels associated therewith as advertising spot data. A central processor is integrated in the system 10 for receiving and processing the advertising spot data and transmitting the advertising spot date to the broadcast network for playing the advertising spot at the selected date and time.

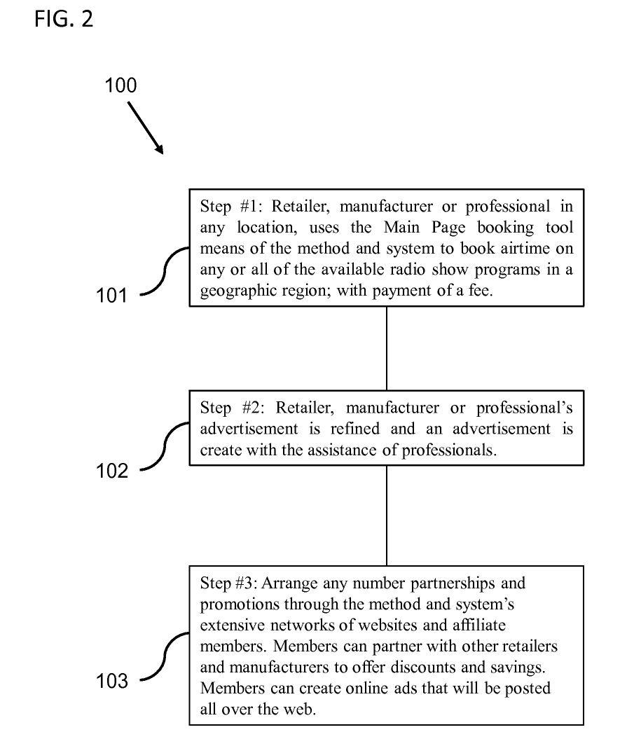

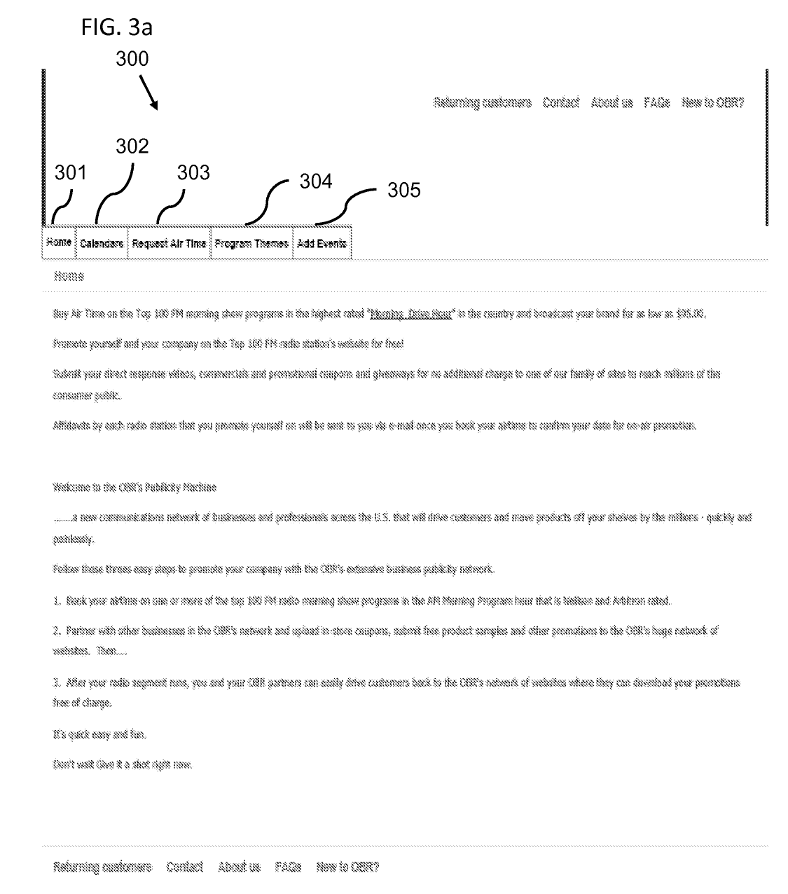

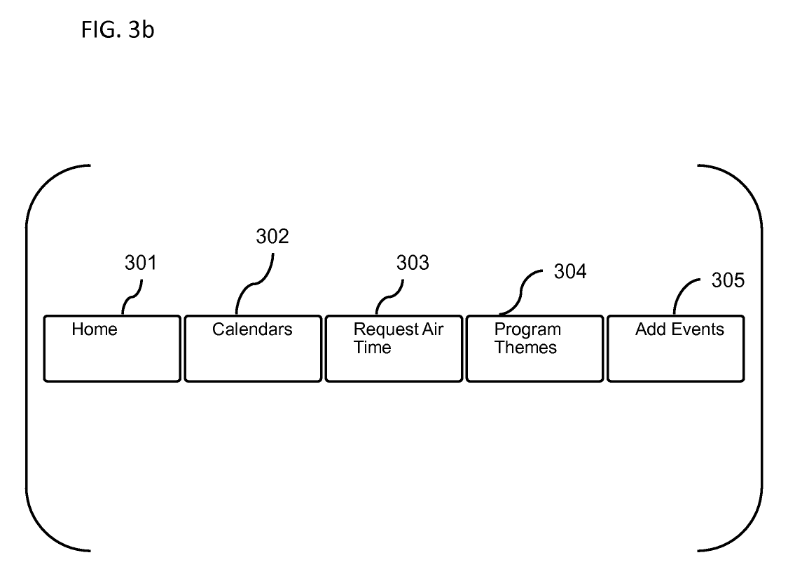

FIG. 2 is a flow chart of an embodiment of the advertising network grid method, shown generally at 100. FIG. 3a is a webpage snapshot of the “Home” page of the advertising network grid system and method, and FIG. 3b is cross-sectional view of the webpage snapshot showing the “Home” tool bar showing the major operations of the system 10, including “Home”, “Calendars”, “Request Air Time”, “Program Themes” and “Add Events”. Referring to FIGS. 1-3b, a user/advertiser 20 enters the system grid 10 through his/her electronic device. If user 20 is a registered user, user 20 is prompted to login to the system 10 at 21. If user 20 is not a registered user, user 20 can select “Request Airtime” 23 and enter information as to the user 20, or user 20 can register to become a user and input name, password, etc. at 22 of FIG. 1. Next user 20 can “Request Airtime” 23 to schedule/review/modify airtime. User 20 is prompted to select whether the user 20 is a manufacturer, retailer, professional, or other at 24. User 20 inserts its date request, and can select multiple dates at 25. User 20 selects the city/cities for broadcast of the advertisement at 26. User 20 selects region/regions for broadcast on the grid at 27. User 20 can selected the category for its report to provide a multi-platform advertising platform at 28. User 20 inserts on-air content at 29 and/or web content at 30. The advertising content entered at 29 and/or 30 is transmitted to the administrator 13 for review and consultation. Administrator 13 provides professional marketing services to perfect/tweak the advertising content so that it is optimized for effective marketing in order to create the final advertising add for broadcast at 31. User 20 can partner with other users 20a-n to split airtime spots/slots and costs. Server 11/system 10 transmits the advertising add content from 31 to at least one broadcast network for broadcast in the selected region/city shown at 14a-n, 15a-n.

Referring to FIG. 2, in step #1 at 101 the user 20/retailer, manufacturer, professional or other, in any location uses the main page booking tool means (i.e. calendar means and region selection means) to book airtime on any or all of the available radio show programs in a geographic region, with payment of a fee. In step #2 at 102, the retailer's, manufacturer's, professional's or other advertisement is refined and an advertisement is created with the assistance of professionals (31 in FIG. 1). In step #3 at 103, partnerships can be arranged and promotions through the system's network of websites and affiliate members. Users can partner with other retailers and manufacturers to offer discounts and savings. Users can create online ads that are posted all over the internet web. FIG. 3a, shown generally at 300, and FIG. 3b show a snapshot of the home page and tool bar, with “Home” 301, “Calendar” 302, “Request Air Time” 303, “Program Themes” 304, and “Add Events” 305.

FIG. 4a is a flow chart illustrating an embodiment of the calendar means and region selection means, shown generally at 400. FIG. 4b is a webpage snapshot of the calendar means illustrated when the “Albany N.Y.” regional link is selected; and FIG. 4c is a webpage snapshot of the calendar means illustrated when the “Boston Mass.” regional link is selected. Selection of “Calendar” 401 provides a link to the region selection means. Region selection means 410 includes a data grid with large geographic regions of a broadcast network's channels. The large geographic regions include, in the example shown, (i) Northeast 402, (ii) East Coast 403, (iii) South East 404, (iv) North Midwest 405, (v) Midwest 406, (vi) South West 407, and (vii) West Coast 408. Each large geographic region 402-408 is in turn divided into smaller regional regions (Regions 1-23 for example). For example, Northeast 402 is divided into smaller regional regions Region 1-4 at 420. In turn each smaller regional region 420 is divided into sub-regions relating to cities shown at 421. For example, Region 1 is divided into sub regions/city regions Albany N.Y. 421a, Boston Mass. 421b, Hartford Conn. 421c, Prov. R.I. 421d, and Springfield Mass. 421e. For each of the city regions there is a broadcast channel associated therewith—for example, Albany N.Y. 421a includes channel WKKF. FIG. 4b shows a webpage snapshot of the calendar for a mock date Sep. 3, 2010, showing each day of the month with booking in Region 1/Albany N.Y.—WKKF 421a of FIG. 4a. As another example, FIG. 4c shows a webpage snapshot of the calendar for a mock date Sep. 3, 2010, showing each day of the month with booking in Region 1/Boston Mass.—WXKS 421b of FIG. 4a.

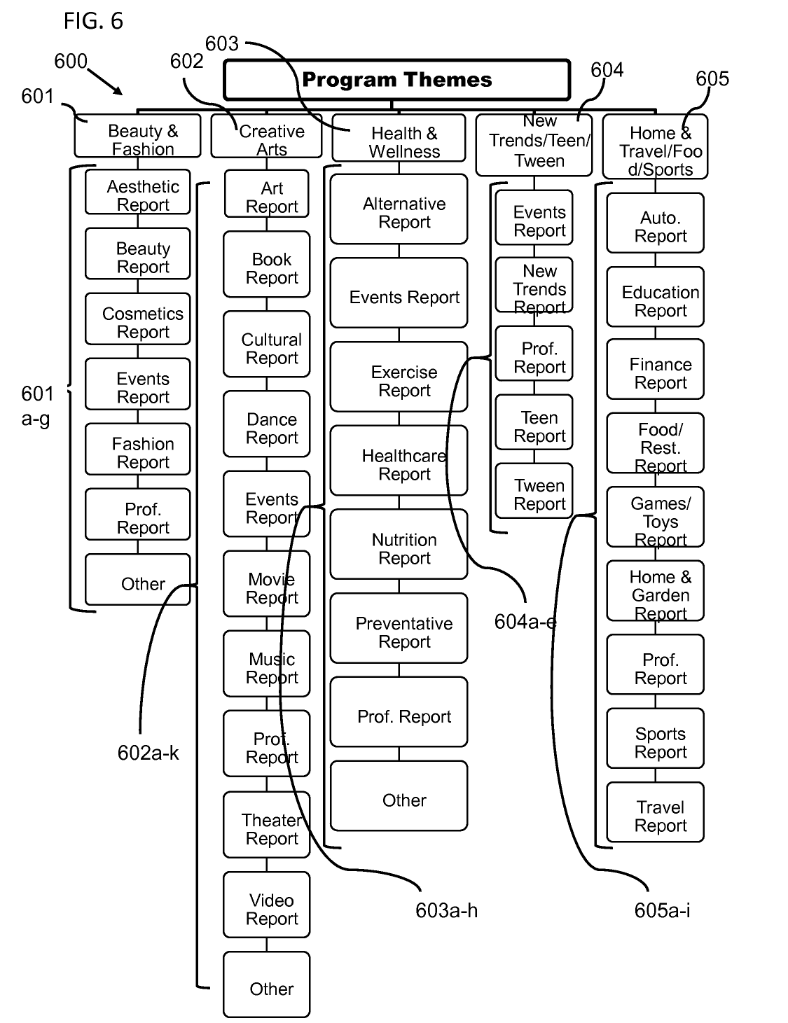

FIG. 5a is a webpage snapshot of the “Request Airtime” link, shown generally at 500. The user scrolls down for selecting radio regional city location/locations via cities. The user can scroll down to select regions 1-23. The user can also scroll to select the category/categories the user desires to advertise in. Each category is linked to a website as discussed via FIG. 6. FIG. 5b is a webpage snapshot of administrative contact response upon a user submitting the “Request Airtime” page from the “Request Airtime” link setting forth that a “representative will contact you shortly with schedules and pricing”. The program theme selection includes a plurality of themes for the user/advertiser to select in conjunction with the advertising content, and wherein each of the themes is linked to an internet website pertaining to the theme to provide at least one internet website venue for advertising. A plurality of categories to select from for scheduling the advertising spot.

FIG. 6 is a flow chart illustrating the “Program Themes” link, and sub-links leading to the themes and individual topic categories, shown generally at 600. Program themes are provided, including “Beauty & Fashion” 601, “Creative Arts” 602, “Health & Wellness” 603, “New Trends/Teen/Tween” 604, and “Home & Travel/Food/Sports” 605. In turn, each program theme 601-605 includes sub-categories 601a-g, 602a-k, 603a-h, 604a-e, and 605a-i. More themes and/or sub-categories may be provided. Each sub-category is linked to its own website having WebPages and links associated with the given topic. For example, selection of “Auto Report” 605a links to a website dealing with automobile issues and information.

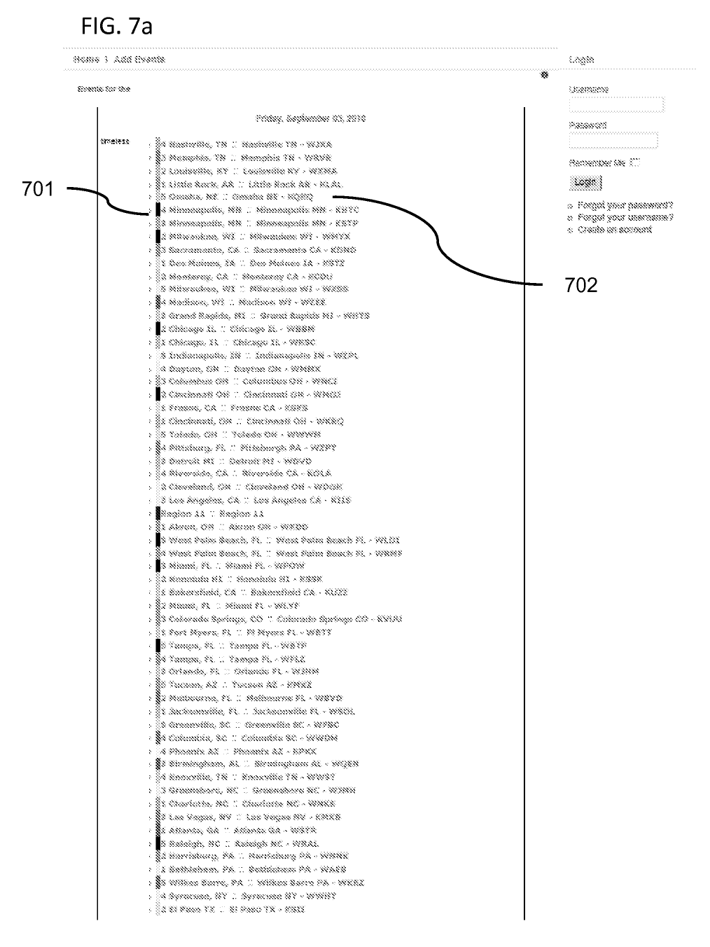

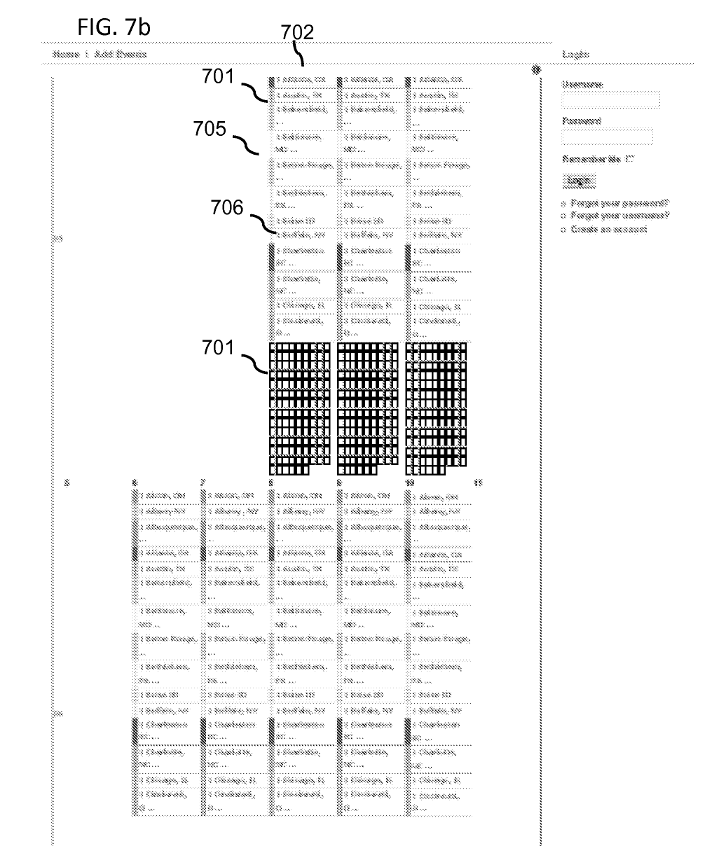

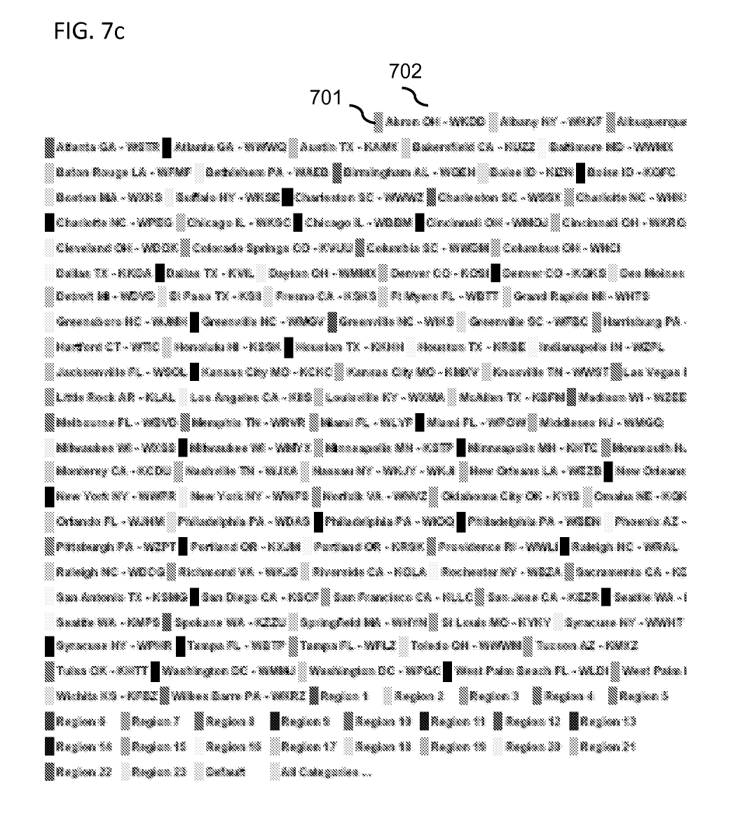

FIG. 7a-7c illustrated webpage snapshots of the “Add Events” link showing the scheduled advertising spots and color coding for each Region/and or city. The “Add Events” shows a calendar, day—week—month—etc.—with entry of the scheduled airtime spots and the region and/or city and radio channel in which the airtime spot is scheduled. FIG. 7a shows a color code grid at 701 associated with each sub-region/city of a region 702. FIG. 7b illustrates a portion of a month with each day 705 including region and city with scheduled airtime spots 706. The color code grid is also shown 701. FIG. 7c further illustrates the color code grid 701 of sub-regions/cities and the associated radio station broadcasting therein.

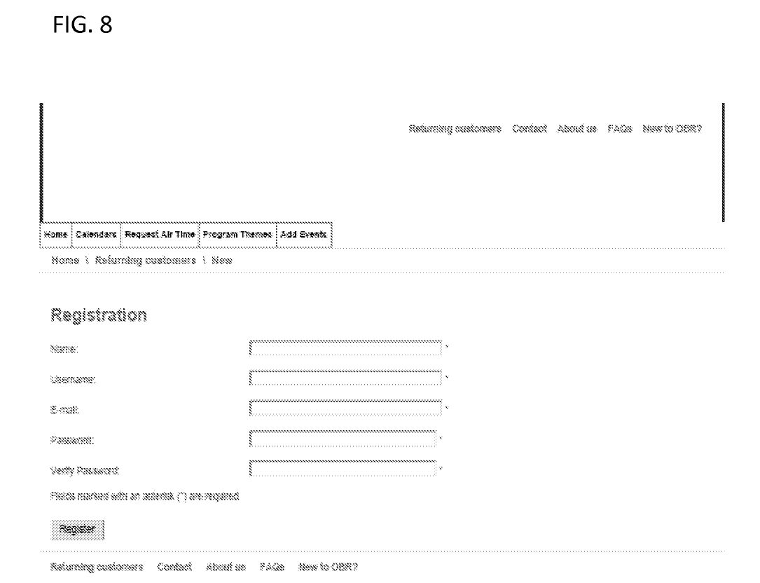

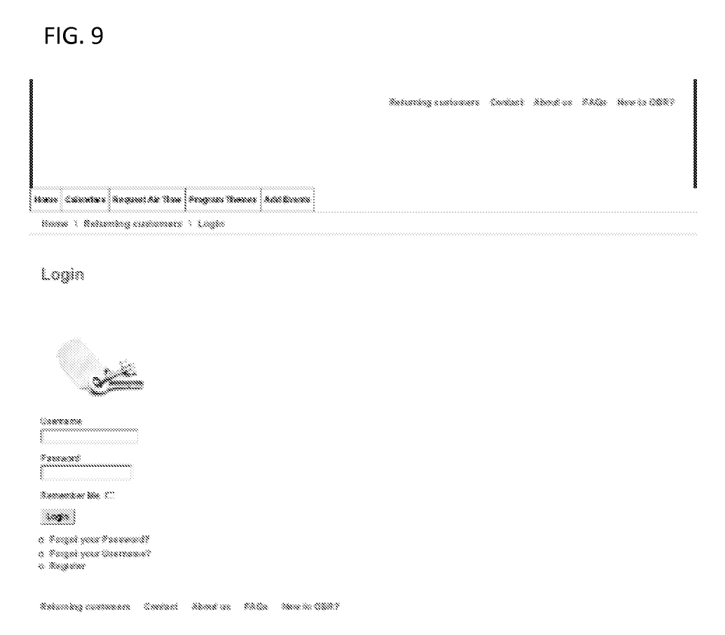

FIG. 8 is a webpage snapshot of the “Registration” link. FIG. 9 is a webpage snapshot of the “Login” link. FIG. 10 is a snapshot of an example pricing structure depending on user type, region, etc. The fee structure preferably provides at least two prices available, a region price and a city price; and the price is further dependent upon the type of user, manufacturer, retailer or professional. Preferably, location partners pay 15% of the media buy (i.e. partnered manufacturer, retailer, and/or professional). Users do not necessary need to have a location partner, however in order to develop local consumer loyalty it is advantageous. Due to the pricing variances in each region, each region block is customized in pricing structure, in addition to have specific pricing allocated for each city. FIG. 10 shows an example breakdown by single city and single region purchases in the Northeast region.

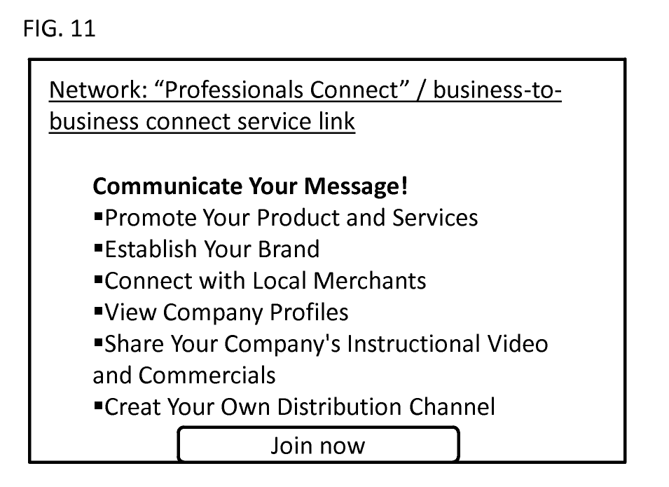

Additionally, preferably a business-to-business connect service is provided by the method and system. The business-to-business connect service allows companies, preferably new companies that have yet to sell their product or service at the local level, to look for and connect with a location partner to host them. All the company has to do is join the grid, upload its company information and feature its product to sell. The business-to-business connect service is preferably in addition to providing coupon codes and sample initiative. FIG. 11 includes a snapshot webpage of the “Professionals Connect”/business-to-business connect service link of the system and method. Each category is listed in addition to each region that the professional/retailer/manufacturer is interested in offering their product in. Businesses can network together to promote products and services, establish brand, connect with local merchants, view company profiles, share company's instructional video and commercials, and/or create company's own distribution channel.

Advantageously, a user can link its promotions on the system to its own website and social network pages. Further, users can join together to share advertising costs and/or to offer related products or services for sale in the selected region, wherein the joined users can publish their name address and/or phone numbers next to each other's content and mention their names live on air during each other's advertising segments. Each of the users incur a percentage, of the media purchase in the city/cities that each user is promoting in only. Preferably, there are four advertising slots available per the advertising channel, i.e. radio station, each day of a business week, wherein up to four users per day are accommodated on the advertising channel. According to one aspect of the invention, the users are grouped by program themes and the broadcast network is affiliate marketing with advertisements and promotions such as a website, Internet, or smart phone application. The variety of topic categories/sub-categories of the program theme are provided in each region, and each of the topic category is associated its own webpage link through the system, and each of the topic categories are featured each week day throughout a month.

The advertising spot may be a 30 second spot. An advertising network grid system for enabling a user/advertiser to schedule advertisement spots on a broadcast network as recited by claim 28, wherein the 30 second spot is divided into two 15 second spots split between two users for cost sharing. The 30 second spot may be divided into two 15 second spots split between a Manufacturer user and a Retailer user or Professional user. Preferably, a plurality of Manufacturers are linked on a weekly basis with at least one regional Retailer, and part of each of the Manufacturer's advertising content includes providing a set minimum value of samples for each linked Retailer during a daily broadcast.

Merchant Tracking Revenue and Payment: Each retail network preferably includes two hosting servers which consist of the system's services that will fully employ journalists, copywriters, blog writers and reporters catering to each one in order to further support existing established merchant relationships. Activity will be closely monitored to ensure adequate space needed for high traffic. Once the current platform is duplicated for each retail establishment the retailer will have the opportunity to offer to vendors a new way to provide cash back rewards and time-shared broadcast reports that will be available for them to utilize and track return on investment instantly. Advertising content can include a plethora of campaigns, pixels, content, reports, articles, videos, podcasts, FACEBOOK® and TWITTER® feeds.

Merchant Startup Protocol: Once the information is received from merchants, the advertising network grid is set to place pixels inside ad campaigns and coupon codes directly onto the network in the category and region of choice. Each participating merchant will provide directives and approve the cash back reward for each consumer purchase, based on their COGs sold. The percentages allocated might vary depending upon direct purchase online or in stores. Retailers with in the retailer's network will also have the opportunity to dictate their wholesale relationship if a product is sold on line and shipped directly from their vendors' warehouse. After agreements are in place, the system will correlate value pixels inside the creatives that will be published on grid for each merchant participating. The system and method dynamically provides instant consumer spending in addition to implementing a new way to increase awareness to brands for the purpose of moving product off store shelves and online. For example, an amount of $50.00 can be preloaded onto a credit card/or reward card to approximately 20,833 consumers monthly per retail network—totaling 250,000 guaranteed consumers annually. Consumers can then use the reward monies for purchased on the website of the subject system and method.

Cash back consumer reward incentives: The system and method preferably diverts a given amount of money directly into preloaded consumer prepaid credit cards. A given number of consumers will have the opportunity to receive money rewards/coupons, etc. prior to activation over the course of time (i.e. 12 months). As a result, the subject system and method provides a novel way to offer cash-back rewards in order to gain continued consumer loyalty and trust. Additional membership cash back rewards incentives for consumers to receive a percentage of sales priced at retail that they directly purchased in-store or on-line may also be provided. The system and method utilizes a tracking system to effectively manage commissions that are typically allocated to publishers and upload back into the consumer's wallet by way of prepaid credit/cash cards.

Each retail network preferably has its own embedded tracking system that enables the system programmers to place and identify each retail network specific pixels inside the system's icons for placement on consumer's iPads®, phones and personal computers to track their online purchases and in-store coupon redemptions for cash back rewards. The prepaid credit/cash cards will also provide the opportunity to allow retail networks to receive continuous revenue from membership fees that are offered for sale exclusively at stores, spas, salons and medi-practices for the purchase of broadcast media and consumer products outside of their existing vendor relationships.

Once each network is launched, cards will be distributed to the participating retail outlets. The initial monies (i.e. $50.00) allocated to each card will not be activated until the consumer purchases at the participating retail store. Initially the cards will be offered to consumers who buy a given monetary amount (i.e. ˜$40.00) from the merchant list of products and services offered on subject system. Through marketing campaigns and an e-mail confirmation upload, consumers will know that icons will need to be placed on to their iPads®, phones and personal computers to ensure that they receive future cash-back rewards from any purchase made on the network. Consumer purchases are tracked. Once the cards are activated at the store level, a consumer will then sign up to receive cash back monthly from in-store and online purchases.

The subject system and method provides a secure spending and social network site that increases retail sales by providing additional revenue streams and allow consumers cash back rewards. At the time of purchase, consumers will begin to enjoy the benefits of using the card that ensures cash back rewards on their next purchases online or in stores. They will also have the ability to upload money from their own pockets to further use as a bank card daily.

Prepaid Credit Card (i.e. VISA® Card)Consumer User Example: Debbie Smith applies for a prepaid credit card after she initially uses the preloaded gift card worth $50.00 activated at the store. Debbie Smith would then activate the card to receive future rebates and rewards. Activation may be via a phone call, on-line, via phone application, and/or automatic through tracking information based on purchases or via GPS via cellular phone devices at a given retail location. Once the subject system receives her information, a unique indicator is created that identifies her, for example a number value, and simultaneously a new card issued associated therewith. Preferably, confirmation via email/text messaging is delivered that will allow her to upload the retail/OBR network icon, ad or script to her phone, iPad® or computer. In order for her to confirm the use of the tracking cookie, she would uploads the system's icon onto her phone, iPad®, personal computer or car computer. The tracking pixels inside the icon are associated within the system's network and the retailer/manufacturer's network through the sub account created utilizing a value system. Once she makes a purchase on any of system's networks built out for participating retailers or redeems a coupon at the store or restaurant, the tracking system will track same and a commissioned earned will be entered. The system also preferably provides daily transparent activity reports that Debbie Smith can view via email for her own knowledge. Debbie Smith's daily purchases will continue to build ongoing revenue streams. The system will then submit payment to a source x, that in turn will further upload money onto Debbie Smith's account, which will continue to be tracked by the value system that was created for her.

Additional sub-value accounts can be created. For instance, a large nonprofit organization has thousands of members or a school has several thousand students that are instructed to participate in a fund raiser. A sub-account can be created for consumer values listed under the main account. In which case, a value is created that matches the main cardholder's information. Each consumer has a right to purchase from merchant websites directly on the network.

Kiosk centers may also be provided. Preferably, the kiosks are installed within a mall or store. The kiosks enable customers to learn more about the products that they have heard on the radio. Additionally, CD's for home use that can be easily uploaded on to a “smart box” xbox, playstation etc may be provided for users do not have a computer at home. The consumers simply choose the network that they are interested in example: spa, grocery, retail, pharmacy.

Advantageously, the subject system and method provides a unique advertising social network that pays the consumer that purchases product, and not the publisher. The subject system and method offers shopping cash back rewards, video conferencing, movies on demand, music, programming for a compete social media platform for all ages.

Having described the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. An advertising network grid system for enabling a user/advertiser to buy and schedule advertisement spots on at least one media-platform using an electronic device having capability (i) to receive and transmit messages, (ii) accept input via a user interface, and (iii) display messages on an electronic display, the system comprising:
a. a computer-implemented advertising network grid including a server with a database adapted to transmit and receive messages from said user's electronic device, said server being in communication with at least one broadcast network;
b. content entry means for entering content provided by said user/advertiser as advertisement content;
c. calendar means for buying and scheduling at least one date and time for airing said advertisement content;
d. region selection means for selecting at least one region located within said broadcast network wherein said region includes a broadcast channel associated therewith;
e. means for receiving and storing advertisement content, selected date and time and said region and/or channels associated therewith as advertising spot data; and
f. a central processor adapted to receive and process the advertising spot data and transmitting same to said broadcast network for playing said advertising spot at said selected date and time.

2. An advertising network grid system for enabling a user/advertiser to schedule advertisement spots on a broadcast network as recited by claim 1, wherein said electronic device is a computer, smart phone, mobile phone or Personal Digital Assistant (electronic handheld information device) (PDA).

3. An advertising network grid system for enabling a user/advertiser to schedule advertisement spots on a broadcast network as recited by claim 1, wherein said broadcast network is a radio, television, or Internet network.

4. An advertising network grid system for enabling a user/advertiser to schedule advertisement spots on a broadcast network as recited by claim 1, wherein said calendar means provides for daily, weekly and monthly scheduling of multiple dates and times for airing said advertisement content.

5. An advertising network grid system for enabling a user/advertiser to schedule advertisement spots on a broadcast network as recited by claim 1, wherein there are a plurality of regions divided into sub-regions and city regions and wherein each city region includes at least one broadcast channel associated therewith.

6. An advertising network grid system for enabling a user/advertiser to schedule advertisement spots on a broadcast network as recited by claim 1, wherein there is a plurality of broadcast channels associated with each said region.

7. An advertising network grid system for enabling a user/advertiser to schedule advertisement spots on a broadcast network as recited by claim 1 comprising a program theme selection.

8. An advertising network grid system for enabling a user/advertiser to schedule advertisement spots on a broadcast network as recited by claim 7, wherein said program theme selection includes a plurality of sub-categories for said user/advertiser to select in conjunction with said advertising content, and wherein each of said sub-categories is linked to an internet website pertaining to said sub-category/topic to provide at least one internet website venue for advertising in a specific topic area.

9. An advertising network grid system for enabling a user/advertiser to schedule advertisement spots on a broadcast network as recited by claim 1 comprising a secondary advertising spot comprising internet advertising on at least one internet website venue.

10. An advertising network grid system for enabling a user/advertiser to schedule advertisement spots on a broadcast network as recited by claim 1, wherein said broadcast network comprises at least one radio network, and said media-platform comprises said radio network and at least one Internet website.

11. An advertising network grid system for enabling a user/advertiser to schedule advertisement spots on a broadcast network as recited by claim 1 comprising a multi-platform including blogs, podcasts, videos, cash back rewards, movies, teleconferences, instant messaging, and music.

12. An advertising network grid system for enabling a user/advertiser to schedule advertisement spots on a broadcast network as recited by claim 1, wherein said advertising content includes instructional videos, news, promotional literature, coupons and sample gift giveaways, and/or combinations thereof.

13. An advertising network grid system for enabling a user/advertiser to schedule advertisement spots on a broadcast network as recited by claim 1 comprising a fee structure wherein there are at least two prices available, a region price and a city price.

14. An advertising network grid system for enabling a user/advertiser to schedule advertisement spots on a broadcast network as recited by claim 1, wherein said user can link its promotions on said system to its own website and social network pages.

15. An advertising network grid system for enabling a user/advertiser to schedule advertisement spots on a broadcast network as recited by claim 1, wherein said shared advertising cost means is provided so that users join together to share advertising costs and/or to offer related products or services for sale in said selected region, wherein said joined users can publish their name address and/or phone numbers next to each other's content and mention their names live on air during each other's advertising segments.

16. An advertising network grid system for enabling a user/advertiser to schedule advertisement spots on a broadcast network as recited by claim 1, wherein there are four advertising slots available per said advertising channel, i.e. radio station, each day of a business week, wherein up to four users per day are accommodated on said advertising channel.

17. An advertising network grid system for enabling a user/advertiser to schedule advertisement spots on a broadcast network as recited by claim 1 comprising a business-to-business connect service link wherein businesses can network together to promote products and services, establish brand, connect with local merchants, view company profiles, share company's instructional video and commercials, and/or create company's own distribution channel.

18. An advertising network grid system for enabling a user/advertiser to schedule advertisement spots on a broadcast network as recited by claim 1 comprising a prepaid card or prepaid reward account assigned to a user consumer.

19. A computer readable medium having embodied thereon a program, the program being executable by a processor for performing a method for rewarding consumers on an advertising network grid system providing multiple media-platforms, the method comprising the steps of:
a. displaying advertising and/or news content associated with a good or service on at least one broadcast network using a computer-implemented advertising network grid including a server with a database adapted to transmit and receive messages from said user's electronic device, said server being in communication with at least one broadcast network;
b. distributing a prepaid card or prepaid reward account with a reward value thereon to a user consumer using said broadcast network;
c. assigning a unique identification indicator to said prepaid card/reward account and/or to said consumer;
d. rewarding said consumer for purchases and/or activity on said broadcast network through compensation on said prepaid card or reward account.

20. A computer readable medium having embodied thereon a program, the program being executable by a processor for performing a method for displaying a schedule of advertisement spots on an advertising network grid system providing multiple media-platforms, the method comprising the steps of:
a. requesting at least one advertising spot on at least one broadcast network using a computer-implemented advertising network grid including a server with a database adapted to transmit and receive messages from said user's electronic device, said server being in communication with at least one broadcast network;
b. entering content through entry means included within said grid for entering content provided by said user/advertiser as advertisement content;
c. selecting at least one date and time for reserving said advertising spot through calendar means included within said grid for buying and scheduling airing of said advertisement content;
d. selecting at least one region through selection means included within said grid for selecting at least one region located within said broadcast network wherein said region includes a broadcast channel associated therewith;
e. receiving and storing said advertisement content through database means, and selected date and time and said region and/or channels associated therewith and reserving same as advertising spot data;
f. receiving and processing said advertising spot data through a central processor; and
g. transmitting said advertising spot data to said broadcast network for reserving and playing said advertising spot at said selected date and time.
